(19) United States
(12) Patent Application Publication
(10) Pub. No.: US 2010/0111660 A1
(43) Pub. Date: May 6, 2010

(54) Self-Propelled Vessel Launch and Retrieve Vehicle

(76) Inventor: Kevin Michael Mathews, Lower Hutt (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/572,351

(22) Filed: Oct. 2, 2009

(30) Foreign Application Priority Data
Oct. 2, 2008 (NZ) 571730

(51) Int. Cl. B60P 3/10; B62D 59/04

(52) U.S. Cl. 414/469; 414/559; 280/414.1

(57) ABSTRACT

A self-propelled water craft launch and retrieve vehicle which comprises a central chassis which includes a cradle for carrying a boat and from which the boat may be launched and retrieved, forward wheels or rear wheels steerable under remote control, hydraulic motors for driving the wheels, elevated above the chassis a prime mover or electric motor and hydraulic pump(s) for powering the wheel hydraulic motors, and a hand held remote control unit operable by an operator standing beside or near the vehicle to cause the vehicle to move forward or to reverse and to steer the launch vehicle.

### FIELD OF INVENTION

The invention comprises a vehicle for launching and retrieving a water craft or boat.

### BACKGROUND

Trailed water craft or boats (herein: boat(s)) are launched into water and retrieved from a trailer towed behind a road vehicle such as a car, SUV, tractor or similar. To launch the boat the trailer is backed down a launching ramp or beach into the water to a sufficient depth to enable the boat to be moved rearwardly off the trailer and into the water, following which the trailer is towed back up the launching ramp. The reverse is done to retrieve the boat, namely the trailer is backed into the water by a towing vehicle, to enable the boat to be hauled back onto the trailer via a retrieve winch and cable, following which the vehicle pulls the trailer and boat from the water.

A disadvantage of launching and retrieving a boat via a trailer towed by a towing vehicle is that the foreshore of the sea or lake in which the launching or retrieving is to be carried out must be sufficiently firm without obstacles for the towing vehicle and trailer to operate unimpeded and without becoming bogged down. Also one person is required to drive the towing vehicle while typically at least one other person handles launching and retrieving of the boat from or onto the trailer.

### SUMMARY OF THE INVENTION

It is an object of the invention to provide an improved or at least alternative form of boat launch and retrieve vehicle.

In broad terms the invention comprises in one aspect a self-propelled water craft launch and retrieve vehicle which comprises:

a central chassis which includes a cradle for carrying a boat and from and onto which the boat may be launched from and retrieved onto the vehicle,

at least one pair of forward wheels at or towards a forward end of the chassis and at least one pair of rear wheels at or towards a rear end of the chassis, at least one of said wheel pairs being steerable under remote control,

hydraulic motors associated one with each of at least one pair of forward wheels and at least one pair of rear wheels for driving said wheels,

mounted at or towards the forward end of the chassis and elevated above the chassis a prime mover or electric motor, and hydraulic pumps driven by the prime mover or electric motor for powering the wheel hydraulic motors, at least one hydraulic pump arranged to drive a said pair of forward wheels and at least one other hydraulic pump arranged to drive a said pair of rear wheels, and

a hand held remote control unit operable by an operator standing beside or near the vehicle to cause the vehicle to move forward or to reverse and to steer the launch vehicle to the left or right.

In broad terms the invention comprises in another aspect a self-propelled water craft launch and retrieve vehicle which comprises:

a central chassis which includes a cradle for carrying a boat and from and onto which the boat may be launched from and retrieved onto the vehicle from a rear end of the chassis, the chassis also comprising a forward part mounting at least one pair of forward wheels and a rear part mounting at least one pair of rear wheels, which forward and rear chassis parts are coupled for limited movement relative to one another about an axis extending longitudinally of the vehicle, said cradle for carrying a boat being provided on said rear part of the chassis, and at least one of said wheel pairs being steerable under remote control,

hydraulic motors associated one with each of at least one pair of forward wheels and at least one pair of rear wheels for driving said wheels, and mounted at or towards the forward end of the chassis and elevated above the chassis a prime mover or electric motor and a hydraulic pump or pumps driven by the prime mover or electric motor for powering the wheel hydraulic motors, and

a hand held remote control unit operable by an operator standing beside or near the vehicle to cause the vehicle to move forward or to reverse and to steer the launch vehicle to the left or right.

The launch and retrieve vehicle of the invention is self-propelled via a hydraulic motor at each of at least two forward and two rear wheels. The vehicle is thus 4WD, and is not towed by a separate towing vehicle. Optionally the vehicle may have more than four wheels—additional wheels may or may not be driven. Also at least two wheels and typically two forward or front wheels are steerable. At least in preferred embodiments both drive to the wheels and steering are controlled by remote control system including a separate remote control command unit which may comprise a wireless hand held unit so that the vehicle can be controlled either by a person standing on the beach near the vehicle, or by a person in the boat either on the vehicle while being launched or approaching the beach to be retrieved and calling the vehicle into the water for retrieval of the boat. A prime mover such as a petrol or diesel engine for example or alternatively a battery powered electric motor is mounted in an elevated position at or towards a forward end of the vehicle, and drives a hydraulic pump or pumps which in turn drive(s) each hydraulic motor at the driven wheels of the vehicle.

### BRIEF DESCRIPTION OF THE DRAWINGS

The invention is further described with reference to the accompanying drawings which show a preferred embodiment of the self-propelled launch and retrieve vehicle by way of example and without intending to be limiting. In the drawings:

FIG. 1 is a perspective view from the front of the preferred embodiment of the launch and retrieve vehicle carrying a boat and on a beach adjacent the waters edge,

FIG. 2 is a perspective view from a rear corner of the launch and retrieve vehicle on a beach and not carrying a boat,

FIG. 3 is a view from the front of the launch and retrieve vehicle,

FIG. 4 is a closer view than FIG. 3, of the front of the launch and retrieve vehicle on one side, showing the steering linkage to and hydraulic motor of a front wheel on that side,

FIG. 5 is a plan view of the chassis of the preferred embodiment launch and retrieve vehicle,

FIG. 6 shows a hand held remote control command unit,

FIG. 7 is a view from one side at the rear of the vehicle illustrating movement of a tilt cradle carried by and forming part of the chassis of the vehicle,

FIG. 8 is a view of the launch and retrieve vehicle after reversing into the water from a beach sufficiently to enable a large boat to be moved onto the vehicle during retrieval, and with the main chassis and wheels of the vehicle submerged, and

FIG. 9 is a side view of the launch and retrieve vehicle at the waters edge with a boat hauled partly onto the vehicle with the tilt cradle down.

### DETAILED DESCRIPTION OF PREFERRED EMBODIMENTS

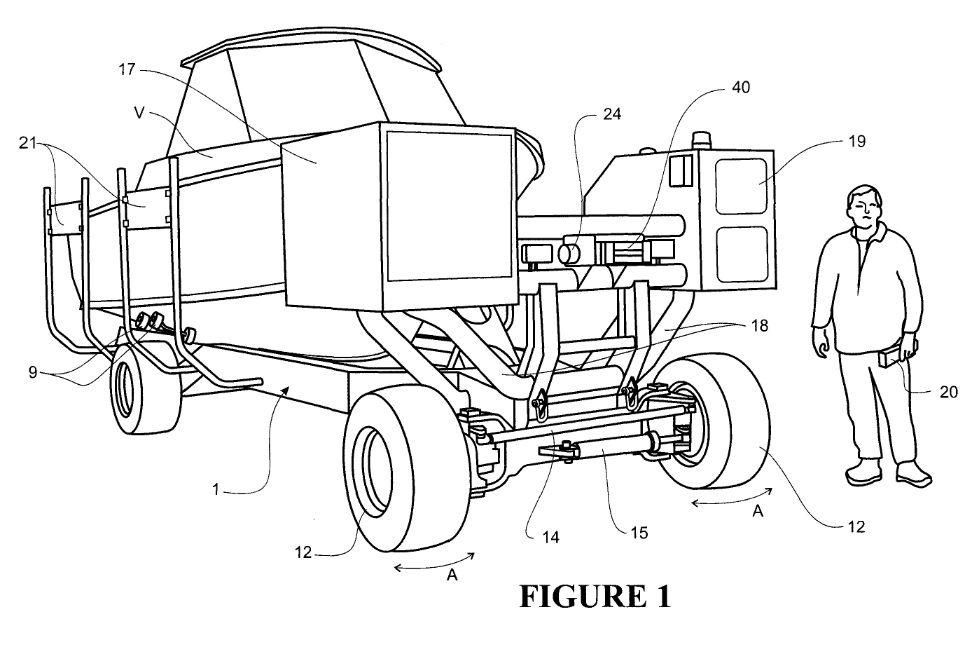

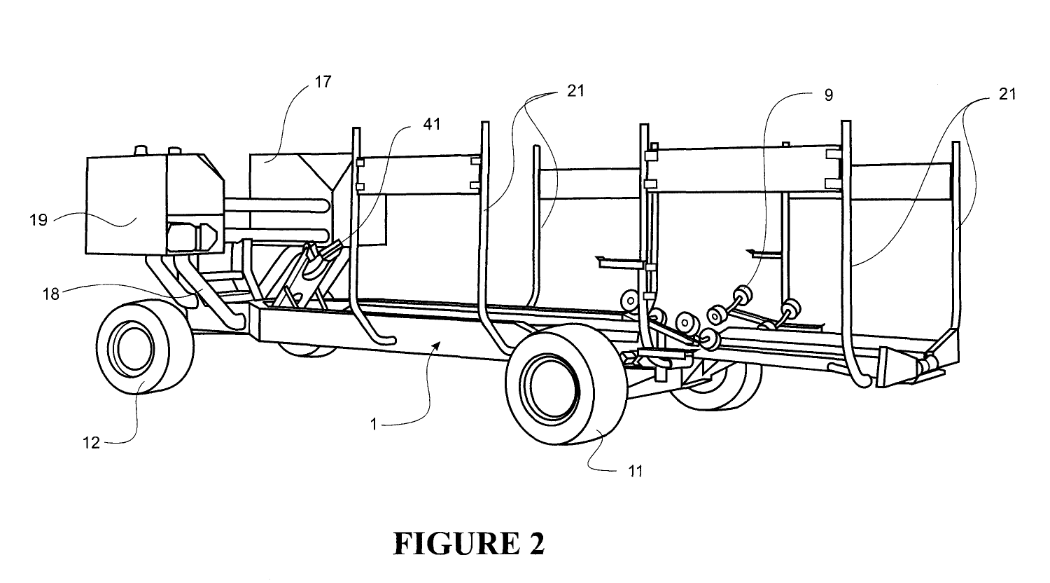

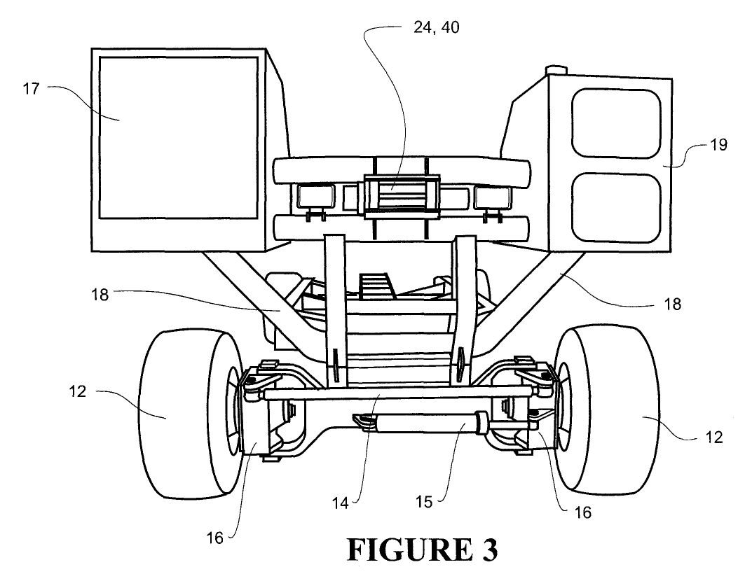

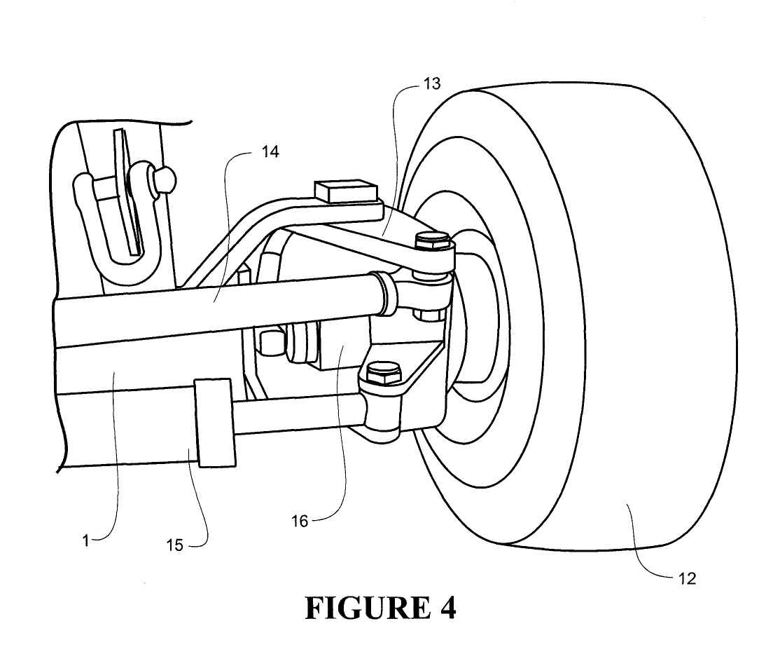

Referring to the drawings and particularly to FIGS. 1 to 5, the preferred embodiment launch and retrieve vehicle includes a chassis generally indicated at 1, which may be in any suitable form but in the preferred form consists of left and right longitudinally extending beams 2 and 3 joined by rear and forward cross members 4 and 5 and optionally also by intermediate cross-members. The chassis mounts a series of spaced rollers 6 between sub-rails 7 and 8 extending centrally and longitudinally of the length of the chassis, on which the keel of a boat may move during launching and retrieving, and by which the weight of the boat is carried through its keel when the boat is on the vehicle. The chassis may also mount rollers 9 and 10 or skids on either side as shown to form a cradle which can stably support the boat on the vehicle. The chassis 1 may be of any suitable mechanical construction. A forward buffer 41 is provided for contact by the bow of a boat when the boat is fully home on the cradle of the vehicle.

The vehicle has a pair of rear wheels 11 and a pair of forward wheels 12. In the preferred form each wheel 11/12 comprises a rim mounting a pneumatic tyre with a coarse all terrain tread, and which is mounted to a wheel hub.

The forward wheels 12 are steerable together and are each pivotally mounted to the chassis 1 via a steering sub-assembly 13 mounting a wheel 12, enabling left and right pivoting movement of the wheels as indicated by arrows A on FIG. 1. The steering sub-assemblies 13 are connected by a steering arm 14, and a ram 15 is provided for steering the wheel pair to the left and right. One end of the ram 15 is coupled to the vehicle chassis and the other end of the ram is coupled to one of the steering sub-assemblies as shown.

A hub drive unit associated with each wheel comprises a hydraulic motor 16 for powering that wheel. Each hydraulic motor 16 is a sealed unit, to prevent ingress of water. A prime mover such as a petrol or diesel engine, or an electric motor, is mounted at or towards the forward end of the chassis in cabinet 17 or cabinet 19 elevated on a sub-frame 18 as shown. A fuel tank and/or battery or batteries may be mounted in either cabinet 17 or cabinet 19 on the same or other side of the vehicle. The prime mover or electric motor drives a hydraulic pump or pumps which supply fluid under pressure to the hydraulic wheel motors 16 and the steering ram 15, via hydraulic lines which in the preferred form pass down through the interior of tubular parts of the sub-frame 18 and along the chassis 1 to protect the hydraulic lines as much as possible. A solenoid-controlled hydraulic valving system enables the supply of hydraulic fluid to the wheel motors 16 to be switched to cause the motors to drive the wheels forward or reverse, and to the steering ram 15 to cause the ram to extend to turn the forward wheels in one direction or retract to turn the wheels in the opposite direction.

In the preferred form the prime mover or electric motor drives a multiple number of hydraulic pumps, and preferably one pump per wheel hydraulic motor 16, so that if any individual wheel should lose traction, or alternatively if the hydraulic circuit to any individual wheel should fail, the hydraulic pressure to the other wheel motors will be unaffected and the other wheels will continue to provide drive. Alternatively the prime mover or electric motor may drive for example two hydraulic motors, one of which provides fluid pressure to the forward wheels and the other of which provides fluid pressure to the rear wheels, so that if either forward or rear wheels should lose traction, or either hydraulic circuit fail, then the other wheels will continue to provide some drive to the vehicle.

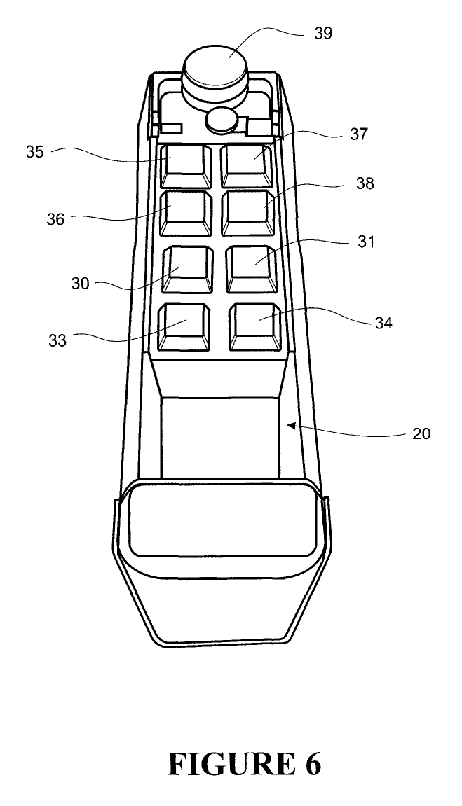

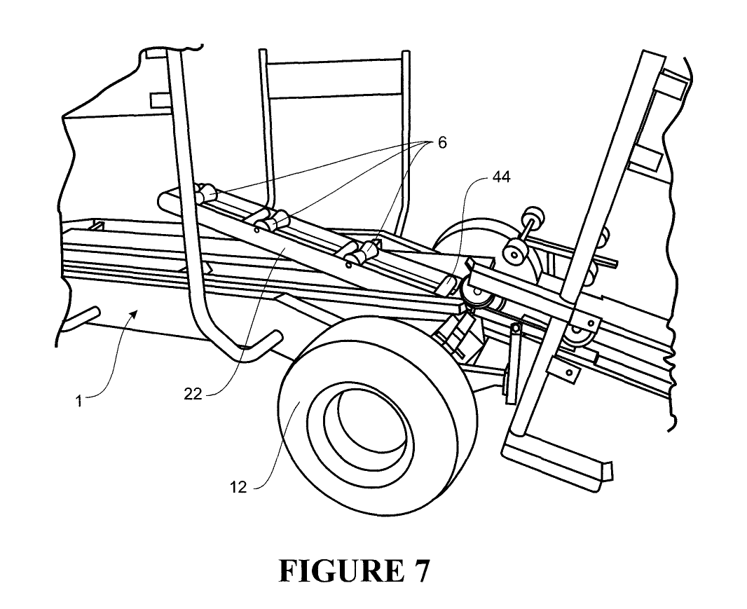

In turn, the hydraulic pump and valves are operated via a remote control system which may also be mounted within one or other cabinet 17 or 19 for example, and which includes a hand held remote control unit 20 shown in FIG. 1 held by a person and in detail in FIG. 6 by way of example. The hand held remote control unit 20 may be operated by for example a person standing on the beach as shown, to cause the launch vehicle to move forward or to reverse at varying speed, and to steer the launch vehicle to the left or right. Referring particularly to FIG. 7 button 30 can be operated to move the vehicle forward and button 31 to reverse the vehicle, and button 33 to steer the forward wheels to the left and button 34 to steer the forward wheels to the right. Button 35 is provided to turn on the ignition system of the vehicle and button 36 to energise the electric starter motor of the prime mover, which is powered from a battery mounted in one or other of the elevated cabinet 17 or 19, and which is charged by an alternator or generator driven by the prime mover when the prime mover is running and/or a solar panel as referred to subsequently. Button 37 on the hand held remote control device may turn on forward and/or rearward facing lights mounted in an elevated position on the vehicle for example in or on the cabinet 17 or 19 or otherwise on the forward sub-frame 18, for night operation, and button 38 may shift the vehicle to higher speed mode as will be described. A kill switch 39 is also preferably provided. The layout of the hand held remote control unit is shown by way of example and in an alternative form the hand held remote control unit may comprise a small joystick which may be operated to drive the vehicle in forward and reverse at varying speeds and to steer the vehicle to the left and right.

In the preferred form each hydraulic motor 16 has a two speed motor and when the button 38 is not depressed the motors operate in a low speed—high torque mode, while depressing button 38 operates a hydraulic valve within each wheel motor 16 to move the motors to a high speed mode, for moving the vehicle more quickly on a beach or beach access road for example.

In the preferred form in addition to the wireless hand held remote control unit 20 a second hand backup remote control unit similar to unit 20 is provided but which is connected to the remote control system of the vehicle via a flexible cable. The second hand held remote control unit is normally stored in a cupboard (accessible from the exterior of the vehicle) in one or other of the cabinet 17 or 19, as a back up in the event of failure of unit 20.

Also in the preferred embodiment a solar panel is provided in the top of one or other or both of cabinets 17 or 19 or elsewhere on the vehicle, for charging the battery.

In the preferred form also a back up hydraulic pump is provided, with an associated electric back up motor, separate from the primary diesel or petrol or electric motor, with an electric circuit which enables the back up electric motor and hydraulic pump to be driven from the battery to provide fluid pressure to the wheel motors 16 and steering ram 15 should the primary motor and/or primary pump(s) fail.

In the preferred form the drive coupling at each wheel may be disengaged to put the driven wheels into a free wheel mode for towing of the vehicle if necessary. For example a hydraulic valve in each motor 16 may be operated mechanically at each wheel, or remotely through a solenoid associated with the valve.

In a preferred form the vehicle also comprises left and right side frames 21, which may also enable an operator to clearly see the position of the vehicle when it has been reversed into the water to an extent that the chassis and drive wheels of the vehicle are submerged.

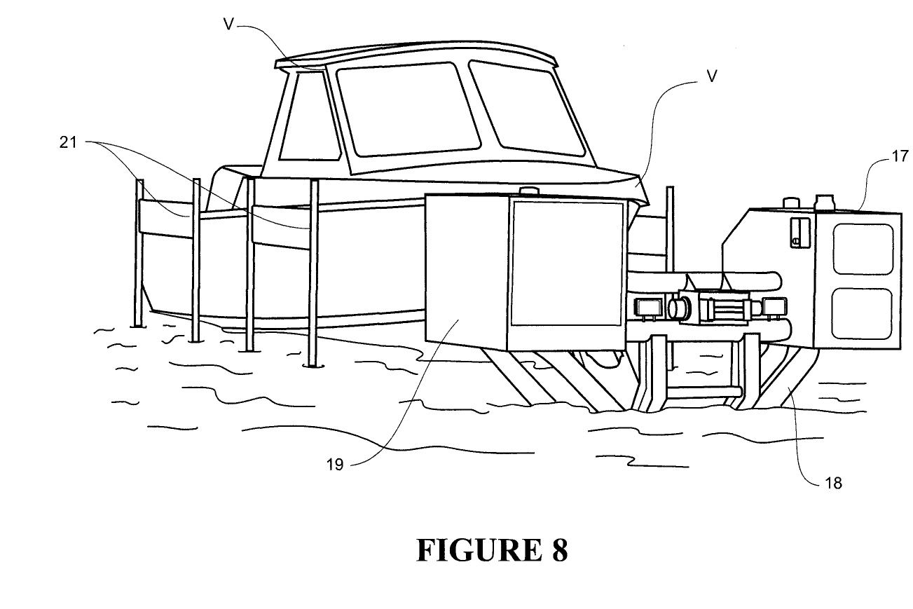

FIG. 1 shows the vehicle on a beach adjacent the waters edge, carrying a boat indicated at V. FIG. 8 it shows the vehicle reversed into the water to a sufficient depth to enable a boat to be driven off or driven onto the vehicle, as shown. To initially launch a boat carried on the vehicle the hand held remote control unit 20 is used to reverse the vehicle down a beach and into the water, to a sufficient depth to enable the boat to then be rolled off the vehicle. It is possible to reverse the vehicle carrying the boat into the water relatively deeply to float the boat off the vehicle. The motor of the boat such as an outboard motor may be started and used in reverse to pull the boat off the launch vehicle. The vehicle may be controlled by the unit 20 by a person standing on the beach or by a person in the boat itself while on the vehicle. After the boat has been launched the operator may use the remote control unit from on the beach or on the boat to drive the launch and retrieve vehicle out of the water and back up onto the beach. To carry out a retrieve operation, a person on the boat may use the remote control unit from onboard the boat, to call the vehicle from the beach back down towards the waters edge and into the water, to enable the boat to be driven onto the vehicle following which the operator may cause the vehicle carrying the boat to move out of the water and up onto the beach to complete the retrieve operation.

Optionally a winch 24 may be mounted centrally on the sub-frame 18, carrying a cable which may be hooked onto the front of a boat to haul the boat onto the vehicle during retrieve operations. If so, the remote control command unit 20 may also include a switch enabling remote control of the winch, which may be powered by a hydraulic or electric motor. Where a winch is provided, optionally cable rollers 40 may be provided on the front side of the winch housing as shown to enable the winch cable to be brought forward and the same winch used to haul the vehicle forward after attaching the winch cable to a solid anchor point or object on land, should the vehicle become fully bogged down or all drive systems of the vehicle fail completely for example.

In the preferred form a water sensitive switch is mounted at an appropriate height at a suitable point on the vehicle, which operates should the vehicle be reversed into water beyond the depth of the water sensitive switch to cut drive to the vehicle to prevent it from reversing further into the water, beyond its safe maximum operating depth. The control system may allow the vehicle only to be driven forward from this point but not further reversed.

Each of the four wheels 11/12 is independently driven by a hydraulic motor. Thus if one wheel should lose traction or become bogged down this will not affect to drive to the other three wheels which will continue to propel the vehicle. In the preferred embodiment described the forward wheels are steerable but alternatively the forward wheels may be fixed and the rear wheels steerable or alternatively again all four wheels may be steerable. In the preferred embodiment described four wheels are provided but an alternative embodiment a greater number of wheels may be provided such as for example two pairs of wheels at or towards the rear of the chassis and a single pair at the front. One or alternatively both of the rear wheel pairs may comprise associated hydraulic motors as described. In the preferred form a prime mover or electric motor and hydraulic pump(s) and system and control system and back up drive system are mounted in cabinets 17 and 19 on either side of the forward sub-frame 18 but alternatively all may be centrally mounted in a single cabinet. Preferably a cabinet or cover(s) is provided to protect these parts of the vehicle from water and/or weather but this may not be essential.

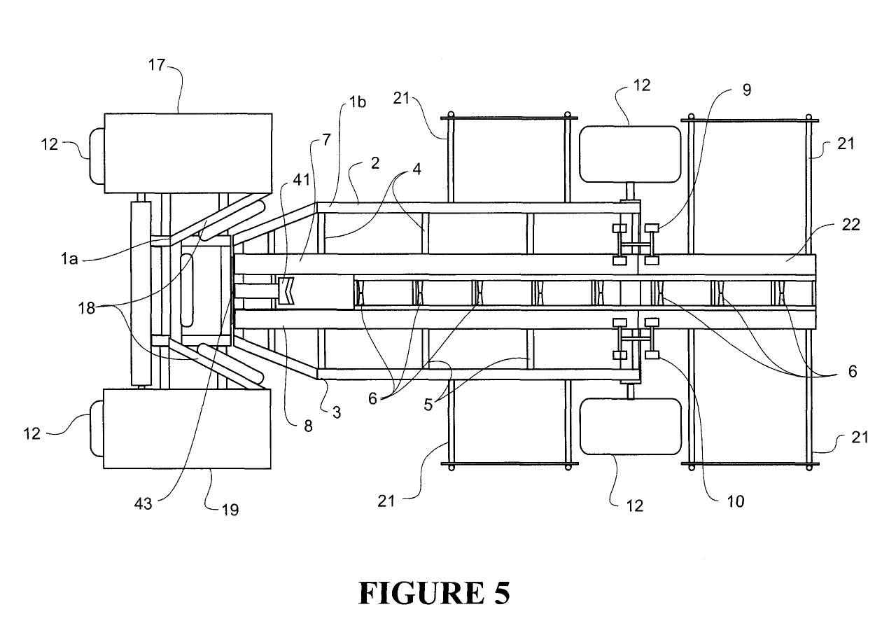

Referring to FIG. 5, in the preferred form the chassis 1 of the vehicle is broken between a forward part 1a to which the forward wheels and steering system are mounted and which mounts the elevated sub-frame 18, and cabinets 17 and 19 etc, and a rear part 1b which comprises the major part of the vehicle chassis and comprises the cradle for holding a boat, and the two chassis sections 1a and 1b are coupled by a pivot at 43 which enables them to pivot relative to one another about a longitudinal axis (aligned with the length of the chassis). This assists the forward and rear wheels in maintaining traction on uneven ground which would be lost if all wheels were mounted to a rigid chassis, while at the same time avoiding the complexity of a suspension system which would add cost as well as more moving parts that would be submerged when the vehicle is used and therefore prone to corrosion. However in another embodiment a simple suspension system may be provided at the rear and/or forward wheels of the vehicle.

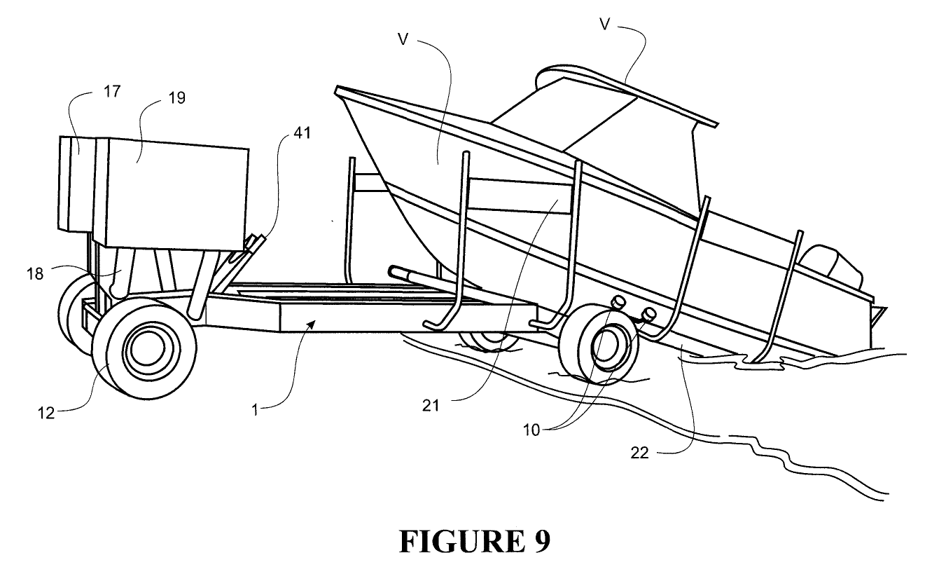

Referring to FIG. 6 in the preferred form rollers 6 or at least some are carried by a central chassis sub-frame 22 which can pivot about an transverse axis at or near the rear of the chassis to the position shown in FIG. 9 which may assist during launch and retrieve of a boat when it is necessary to haul a boat onto the vehicle from a shallower water for example where it is not possible to reverse the vehicle further into the water than shown in FIG. 9 for any reason. Spring loaded locking pins may be provided between the chassis sub-frame 22 and the main chassis 1 on either side which can be manually released to enable the chassis sub-frame 22 to be tilted to the position shown in FIGS. 6 and 9, and which will snap-lock between the main chassis 1 and the chassis sub-frame 22 when the sub-frame 22 is moved back into its normal position, as a boat rides up onto the vehicle or if the sub-frame 22 is moved back to its normal position manually.

The preferred form is described by way of example and alterations and modifications as will be obvious to those skilled and are intending to be incorporated within the scope hereof as defined in the accompanying claims.

1. A self-propelled water craft launch and retrieve vehicle which comprises:
a central chassis which includes a cradle for carrying a boat and from and onto which the boat may be launched from and retrieved onto the vehicle,
at least one pair of forward wheels at or towards a forward end of the chassis and at least one pair of rear wheels at or towards a rear end of the chassis, at least one of said wheel pairs being steerable under remote control,
hydraulic motors associated one with each of at least one pair of forward wheels and at least one pair of rear wheels for driving said wheels,
mounted at or towards the forward end of the chassis and elevated above the chassis a prime mover or electric motor, and hydraulic pumps driven by the prime mover or electric motor for powering the wheel hydraulic motors, at least one hydraulic pump arranged to drive a said pair of forward wheels and at least one other hydraulic pump arranged to drive a said pair of rear wheels, and
a hand held remote control unit operable by an operator standing beside or near the vehicle to cause the vehicle to move forward or to reverse and to steer the launch vehicle to the left or right.

2. A self-propelled water craft launch and retrieve vehicle according to claim 1 comprising an individual hydraulic pump driven by the prime mover or electric motor to drive each driven wheel of the vehicle.

3. A self-propelled water craft launch and retrieve vehicle according to claim 1 wherein the hand held remote control command unit is arranged to communicate with a control system of the vehicle wirelessly.

4. A self-propelled water craft launch and retrieve vehicle according to claim 3 comprising a second backup hand held remote control command unit connected to the vehicle via a cable.

5. A self-propelled water craft launch and retrieve vehicle according to claim 1 capable of operating in a slow speed-high torque mode and a higher speed mode.

6. A self-propelled water craft launch and retrieve vehicle according to claim 1 including a backup hydraulic pump, associated electric motor for driving the backup hydraulic pump, and a battery to provide power to the electric motor.

7. A self-propelled water craft launch and retrieve vehicle according to claim 1 including a solar panel for charging a battery of the vehicle.

8. A self-propelled water craft launch and retrieve vehicle according to claim 1 including a winch operable to haul a boat onto the vehicle and/or haul the vehicle.

9. A self-propelled water craft launch and retrieve vehicle according to claim 1 including a water sensitive switch on the vehicle arranged to cut drive to the vehicle should the vehicle be reversed into water to the depth of the water sensitive switch.

10. A self-propelled water craft launch and retrieve vehicle according to claim 1 wherein the chassis of the vehicle comprises a central sub-frame at the rear of the vehicle carrying one or more rollers or skids and tiltable about a transverse axis at or near the rear of the chassis to assist during launch and retrieve of a boat, and which is lockable in a non-tilted position relative to the main chassis.

11. A self-propelled water craft launch and retrieve vehicle which comprises:
a central chassis which includes a cradle for carrying a boat and from and onto which the boat may be launched from and retrieved onto the vehicle from a rear end of the chassis, the chassis also comprising a forward part mounting at least one pair of forward wheels and a rear part mounting at least one pair of rear wheels, which forward and rear chassis parts are coupled for limited movement relative to one another about an axis extending longitudinally of the vehicle, said cradle for carrying a boat being provided on said rear part of the chassis, and at least one of said wheel pairs being steerable under remote control,
hydraulic motors associated one with each of at least one pair of forward wheels and at least one pair of rear wheels for driving said wheels, and mounted at or towards the forward end of the chassis and elevated above the chassis a prime mover or electric motor and a hydraulic pump or pumps driven by the prime mover or electric motor for powering the wheel hydraulic motors, and
a hand held remote control unit operable by an operator standing beside or near the vehicle to cause the vehicle to move forward or to reverse and to steer the launch vehicle to the left or right.

12. A self-propelled water craft launch and retrieve vehicle according to claim 11 wherein the hand held remote control command unit is arranged to communicate with a control system of the vehicle wirelessly.

13. A self-propelled water craft launch and retrieve vehicle according to claim 12 comprising a second backup hand held remote control command unit connected to the vehicle via a cable.

14. A self-propelled water craft launch and retrieve vehicle according to claim 11 capable of operating in a slow speed-high torque mode and a higher speed mode.

15. A self-propelled water craft launch and retrieve vehicle according to claim 11 including a backup hydraulic pump, associated electric motor for driving the backup hydraulic pump, and a battery to provide power to the electric motor.

16. A self-propelled water craft launch and retrieve vehicle according to claim 11 including a solar panel for charging a battery of the vehicle.

17. A self-propelled water craft launch and retrieve vehicle according to claim 11 including a winch operable to haul a boat onto the vehicle and/or haul the vehicle.

18. A self-propelled water craft launch and retrieve vehicle according to claim 11 including a water sensitive switch on the vehicle arranged to cut drive to the vehicle should the vehicle be reversed into water to the depth of the water sensitive switch.

19. A self-propelled water craft launch and retrieve vehicle according to claim 11 wherein the chassis of the vehicle comprises a central sub-frame at the rear of the vehicle carrying one or more rollers or skids and tiltable about a transverse axis at or near the rear of the chassis to assist during launch and retrieve of a boat, and which is lockable in a non-tilted position relative to the main chassis.
